(19) United States
(12) Patent Application Publication
(10) Pub. No.: US 2012/0301061 A1
(43) Pub. Date: Nov. 29, 2012

(54) SOOTBLOWER STUFFING BOX AND SEAL

(76) Inventor: Ward Forrest, Edmonds, WA (US)

(21) Appl. No.: 13/116,965

(22) Filed: May 26, 2011

(51) Int. Cl. F16C 33/74; B23P 11/00; F16C 31/02

(52) U.S. Cl. 384/16; 29/428

(57) ABSTRACT

A lance tube stuffing box assembly includes within a seal cavity, a first and a second sleeve bearing oriented to be axially aligned with the bore and with each other and spaced apart within the bore to define a packings space. A plurality of braided packings are situated within the packings space and oriented to be axially aligned with each of the first and second sleeve bearings; and inserted within the bore in opposed relation to the annular wall of the seal cavity a gland follower which is likewise axially aligned and bears against the first bearing with an axial force to narrow the packings space, urging the plurality of braided packings to expand radially, such that when a lance tube is inserted axially. The axial force causes the braided packings to sealingly engage the lance tube.

### FIELD OF THE INVENTION

The inventive stuffing box is a sealing technology and, in particular, a stuffing box having bearings within.

### BACKGROUND OF THE INVENTION

Operators of large-scale boilers are continuously striving to improve the efficiency of their operation. Cleaning highly heated surfaces, such as the heat exchange surfaces of a boiler, furnace, or the like, has commonly been performed by devises generally known as sootblowers. Sootblowers typically employ water, steam, air, or a combination thereof, as a blowing medium which is directed through one or more nozzles against encrustations of slag, ash, scale or other fouling materials which become deposited on the heat exchange surfaces.

One example of a Sootblower mechanism that has proven especially useful is that taught by Hipple in U.S. Pat. No. 6,575,122 issued on Jun. 10, 2003 and entitled, “Oscillating Sootblower Mechanism.” Typical sootblowers of the long retracting type, the Hipple Sootblower has a retractable lance tube which is periodically advanced into and withdrawn from the boiler while simultaneously rotated such that one or more blowing medium nozzles at the end of the lance tube project jets tracing helical paths.

The lance tube, itself is long and narrow and must sealingly engage with a source of superheated steam as the tube, itself, moves both along its transverse axis and rotates around it. Generally one configuration of the sealing mechanism includes a stuffing box or stuffing box. In a conventional stuffing box, the seal itself is provided by packing rings, or a square cross-sectioned rope which is packed or wound tightly around the lance tube and compressed in place with a threaded nut and spacer. As generally configured, then, the lance tube over-fits a feed tube and the stuffing box provides a fluid seal between the lance tube and the feed tube so that blowing medium conducted into lance tube from feed tube is discharged from one or more nozzles at a distal end of lance tube.

As conventionally configured, stuffing boxes tend to wear rapidly and lack appropriate support for the lance tube, allowing nozzles to move out of a centered relation within the heat exchanger and thereby altering the expected spray pattern on the surface creating premature wear where spray patterns overlap and missing portions of the heat exchanger thereby reducing efficiency. Because of their extended length, Lance tubes also exert a torque where supported as gravity draws the tube downward, especially at its distal end. Seals tend to wear unevenly which accentuates the eccentricity of the position over time, yielding even more compromised nozzle patterns. A stuffing box and seal yielding more support and better durability are needed in the art.

### SUMMARY OF THE INVENTION

A lance tube stuffing box assembly includes within a seal cavity, a first and a second sleeve bearing oriented to be axially aligned with the bore and with each other and spaced apart within the bore to define a packings space. A plurality of braided packings are situated within the packings space and oriented to be axially aligned with each of the first and second sleeve bearings; and inserted within the bore in opposed relation to the annular wall of the seal cavity a gland follower which is likewise axially aligned and bears against the first bearing with an axial force to narrow the packings space, urging the plurality of braided packings to expand radially, such that when a lance tube is inserted axially. The axial force causes the braided packings to sealingly engage the lance tube.

### BRIEF DESCRIPTION OF THE DRAWINGS

Preferred and alternative examples of the present invention are described in detail below with reference to the following drawings:

FIG. 1 is a prior art isometric view of a sootblower of the Hipple type offered for nonlimiting context; and

FIG. 2 is a side view of a stuffing box portraying the arrangement of bearings and seals within the seal cavity.

### DETAILED DESCRIPTION OF THE PREFERRED EMBODIMENT

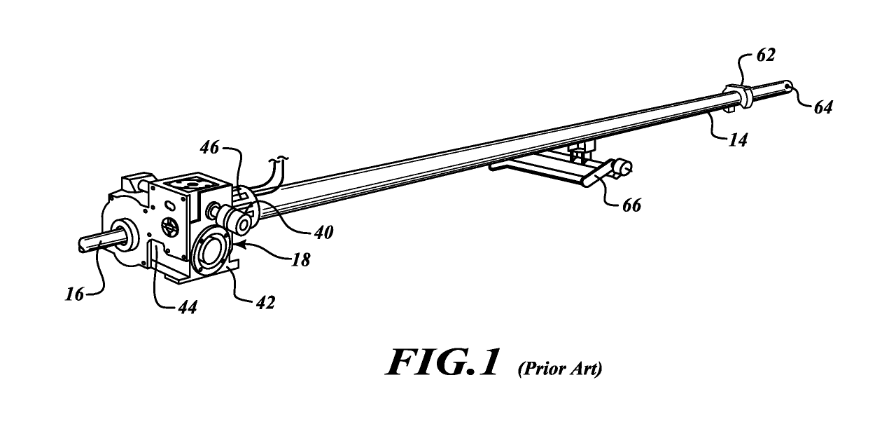

FIG. 1 illustrates a conventional sootblower mechanism, as taught by Hipple, supra, and generally designated there by reference number 10. Sootblower assembly 10 principally comprises frame assembly 12, lance tube 14, feed tube 16, and carriage 18. Sootblower 10 is shown in its normal resting or resting position. Upon actuation, lance tube 14 is extended into and retracted from a boiler (not shown) and is simultaneously oscillated rotationally.

A carriage 18 drives lance tube 14 into and out of the boiler 25 and includes drive motor 40 and gear box 42 which is enclosed by housing 44. Carriage 18 drives a pair of pinion gears 46 which engage the previously mentioned toothed racks to advance carriage 18 and lance tube 14. Bearings 58 and 59 engage with tracks 26 to support carriage 18.

Feed tube 16 is attached at one end to rear bracket 52 and conducts blowing medium which is controlled through the action of poppet valve 54. Poppet valve 54 is actuated through linkages 56 which are engaged by carriage 18 to begin blowing medium (typically steam) discharge upon 35 extension of lance tube 14, and cuts off the flow once the carriage 18 returns to the idle retracted position shown in FIG. 1. Lance tube 14 over-fits feed tube 16 and a fluid seal between them is provided by stuffing box (not shown) so that blowing medium conducted into lance tube 14 from 40 feed tube 16 is discharged from one or more nozzles 64 at the distal end of lance tube 14. For long lance tube lengths, an intermediate support 66 may be provided to prevent excessive bending deflection of the lance tube. Additional details of the construction of a well-known design of the “IK” type sootblower are found in U.S. Pat. No. 3,439,376, which is hereby incorporated by reference.

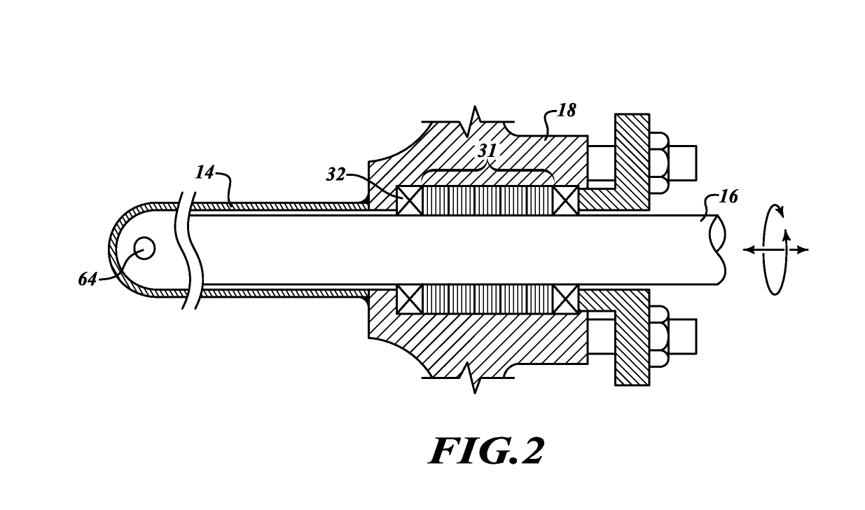

Referring to FIG. 2, the lance tube 14 is supported and sealed within the carriage 18 by a stuffing box assembly 30. The carriage 18 defines a seal cavity 20 housing the stuffing box assembly 30. A proximal end of the seal cavity 20 is defined by a gland follower 22 which encompasses the feed tube 16. The gland follower 22 is mounted on the carriage 18 on gland bolts 23 secured in place with gland nuts 24.

The stuffing box assembly 30 includes two bushing seals referred to herein as vise bearings 31. The vise bearings 31 are shown in side-elevational view. The vise bearings 31 are rigid tubes having substantially cylindrical outer surface, inner bore surface, and annular first and second ends. The diameter of the inner bore is selected to be slightly larger than the diameter of the lance tube and the diameter of the outer surface is selected to be slightly smaller than the diameter of the seal cavity 20. The two vise bearings 31 are spaced apart such that their respective inner bores provide bearing surface for the lance tube 14 supporting it in a position to optimally place the nozzles 64 when the lance tube 14 is activated.

Between the vise bearings 31 there are a plurality of braided packings 32 which, in alternate embodiments include any of a composition used extensively in industry for a variety of sealing purposes. Typically braided packings 32 are made of flax, jute, asbestos or synthetic, such as polytetraflouroethylene, fibers which are formed into yarns or strands and which are braided together about core strands. The result is typically a packing having a square cross-section and herringbone weave pattern extending in an axial direction along the packing; typical such packings are illustrated in U.S. Pat. No. 3,646,846.

One exemplary embodiment of the braided packings 32 is a “Braided High Temperature Packing Comprising a Core of Folded Flexible Graphite Sheet,” such as that taught by U.S. Pat. No. 5,225,262 to Leduc issued on Jul. 6, 1993 and fully incorporated by this reference: “The braided packing of the invention is suitable for high-temperature and high-pressure applications, with functional limits up to 1200.degree. F. and 5,000 psi. The resilience and toughness of the packing is achieved through a flexible packing core of folded, reinforced square plait braided graphite tape overbraided with high strength and high-temperature resistant yarns. The resulting packing is rugged, non-hardening, non-metal, non-stem scoring, and easily removable (e.g., from a packing gland) when it needs to be replaced. The high-temperature/high-pressure resistant packing of the invention has the additional advantage of not requiring the use of asbestos and yet retaining the high-temperature resistant properties of that product. The inner core of the packing can be pre-consolidated to a density approaching the final density and therefore the final product can be live-loaded (e.g., into a valve stem packing gland), thus saving considerable time in the final adjustment of the gland.” An additional and nonlimiting list of suitable packing materials are taught in U.S. Pat. No. 6,644,007 to Fujiwara et al. on Nov. 11, 2003; U.S. Pat. No. 6,502,382 to Fujiwara et al. on Jan. 7, 2003; and U.S. Pat. No. 6,385,956 to Ottinger, et al. on May 14, 2002.

A presently preferred embodiment exploits either or both of braided packings 32 and the vise bearings 31 comprising Polybenzimidazole (PBI) as molded material or as fiber. PBI fiber was first derived in 1983 and is a synthetic fiber with an extremely high melting point that also does not readily ignite, because of its exceptional thermal and chemical stability. The Federal Trade Commission definition for PBI fiber is a “manufactured fiber in which the fiber-forming substance is a long chain aromatic polymer having recurring imidazole groups as an integral part of the polymer chain”. When used as a fiber to make up a braided packing 32, PBI demonstrates superior longevity and sealing capability. While PBI is one suitable constituent, it is not the only such suitable constituent of either the vise bearings 31 or the braided packings 32.

The vise bearings 31 are configured as sleeve bearings but are exploited in this application to serve a novel, important, and nonobvious function in the stuffing box assembly 30. The vise bearings 31 are spaced apart and provide support to the lance tube 14 lending support to the whole of the lance tube that is largely equivalent to that of a bearing that ran from an outer surface of a first vise bearing 31 to that of an opposedly situated vise bearing 31 while preserving a space for the braided packings 32 between the vise bearings 31. Given the elongate arrangement of the lance tube 14, should the center of gravity rest outside of a central point between the first and second vise bearings 31, the weight of the lance tube imparts torque around the vise bearings 31. By their spaced apart configuration, the vise bearings 31 can resist the torque being situated further apart on the lever arm, thereby obtaining a mechanical advantage as compared to the same bearings situated in touching relation. The spaced apart relation, therefore, prevents the torque from deflecting the lance tube 14 and, thereby compromising the sealing conformity of the braided packings 32 with the outer surface of the lance tube 31. While a two bearing solution is described, these advantages are gained by, at least the outer two bearings but might be enhanced by additional bearings at intervals throughout the braided packings 32 in the packings space.

A second but also important function of the vise bearings 31 in cooperation with a gland follower 22, is to compress the braided packings 32 deforming them radially in response to the compressive forces applied axially. The gland follower 22, is urged axially by the suitable torquing of the gland nuts 24 on the gland bolts 23. Torque exerted on the gland nuts 24 caused them to rotate. Because the inner radii of the vise bearings 31 is approximately equal to that of the braided packings 32 and the outer radii of the vise bearings 31 is approximately equal to outer radii of the braided packings 31 (i.e. by approximately equal, the application requires less than ten percent difference between the radii of the uncompressed braided packings 32 and the vise bearings 31). The rotational motion is converted by the meshing of threads on the gland nut 24 and the gland bolts 23 to impart a linear motion axially inward thus converting the torque to a linear force axially inward. In the described fashion, the gland follower 22 exerts the compressive force on the braided packings 32 pressing them inward within the seal cavity 20 into sealing engagement with the lance tube 14.

When suitably assembled, the gland assembly 30 engages the lance tube 14 and forms a suitable seal between it and the feed tube 16 allowing the lance tube to conduct high energy steam from the feed tube 16, through the lance tube 14 to leave the lance tube 14 through any of the several nozzles 64. As a result of the sealing engagement between the gland assembly 30 and the lance tube 14, in operation, the sealing engagement can be so tight as to cause the gland assembly 30 to move in axially and rotate with the lance tube 14 together as an integral assembly.

While the preferred embodiment of the invention has been illustrated and described, as noted above, many changes can be made without departing from the spirit and scope of the invention. For example, neither exact dimension of either of the vise bearings 31 nor the number of braided packings 32 are critical and may be adjusted in accord with the particular application. Accordingly, the scope of the invention is not limited by the disclosure of the preferred embodiment. Instead, the invention should be determined entirely by reference to the claims that follow.

1. A lance tube stuffing box assembly for sealing attaching a lance tube to a steam feed tube in a sootblower, the stuffing box assembly comprising:
within a seal cavity, a bore and an annular wall defines, a first and a second sleeve bearing oriented to be axially aligned with the bore and each other and spaced apart within the bore to define a packings space;
a plurality of braided packings, each braided packing being situated within the packings space and oriented to be axially aligned with each of the first and second sleeve bearings; and
inserted within the bore in opposed relation to the annular wall of the seal cavity a gland follower which is likewise axially aligned and bears against the first bearing with an axial force to narrow the packings space, urging the plurality of braided packings to expand radially, such that when a lance tube is inserted axially, the axial force will cause the braided packings to sealingly engage the lance tube.

2. The stuffing box of claim 1, wherein the braided packings include Polybenzimidazole fiber.

3. The stuffing box of claim 1, wherein the sleeve bearings include Polybenzimidazole.

4. The stuffing box of claim 1, wherein the plurality of braided packings are three or more.

5. The stuffing box of claim 1, wherein each of the plurality of braided packings form a first annular cylinder defined by braided packings inner and outer radii and wherein the sleeve bearings define a second annular cylinder having an inner radius that is approximately equal to the braided packings inner radius and having an outer radius that is approximately equal to the braided packings outer radius.

6. The stuffing box of claim 5, wherein the inner radius of 2.375 inches, an outer radius of 3.375 inches, and length from the outer surface of the first bearing to the outer surface of the second bearing of 4.625 inches.

7. A method for sealingly engaging a lance tube with a steam feed tube, the method comprising:
into a cylindrical seal cavity having an annular wall, inserting a second sleeve bearing arranged coaxially with the seal cavity;
inserting a plurality of braided packings configured as annular cylinders, arranged coaxially with the seal cavity and the second sleeve bearing;
inserting a first sleeve bearing arranged coaxially with the with the seal cavity, the braided packings, and the second sleeve bearing, the first bearing defining in cooperation with the second bearing a packings space; and
inserting a gland follower to urge the first bearing into the packings space deforming the braided packings into sealing engagement with the lance tube and the steam feed tube.

8. The method of claim 7, wherein the first and second sleeve bearing and the braided packings have each of an inner radius and an outer radius and where the inner radii of the sleeve bearings and the braided packings are approximately equal and the outer radius of the sleeve bearings and the braided packings are approximately equal.

9. A bearing apparatus for a lance tube stuffing box assembly for sealing attaching a lance tube to a steam feed tube in a sootblower, the bearing assembly comprising:
within a seal cavity, a bore and an annular wall defines, a first sleeve bearing oriented to be axially aligned with the bore and bearing against a cavity wall both axially against a cavity floor and radially at its outer circumference against the bore, the bearing defining an inner surface to receive the lance tube in rotating engagement, the cavity floor being situated opposite a gland follower;
a packings space, configured to receive a plurality of braided packings, each braided packing being situated within the packings space and oriented to be axially aligned with the first sleeve bearing;
a second sleeve bearing, oriented to be axially aligned with the bore and bearing radially against the gland follower and radially at its outer circumference against the bore, the bearing defining an inner surface to receive the lance tube in rotating engagement,
the bearings being configured and spaced apart to support the lance tube and in use, the gland follower will exert an axial force on the second bearing to compress the packings between the bearings causing the packings to sealingly engage the lance tube.

10. The bearing assembly of claim 1, wherein the sleeve bearings include Polybenzimidazole.

11. The bearing assembly of claim 1, wherein each of the plurality of packings form a first annular cylinder defined by packings inner and outer radii and wherein the sleeve bearings define a second annular cylinder having an inner radius that is approximately equal to the packings inner radius and having an outer radius that is approximately equal to the packings outer radius.

12. The bearing assembly of claim 11, wherein the inner radius of 2.375 inches, an outer radius of 3.375 inches, and length from the outer surface of the first bearing to the outer surface of the second bearing of 4.625 inches.
